(19) United States
(12) Patent Application Publication
(10) Pub. No.: US 2019/0186739 A1
(43) Pub. Date: Jun. 20, 2019

(54) APPARATUS AND METHOD FOR MITIGATING PARTICULATE ACCUMULATION ON A COMPONENT OF A GAS TURBINE ENGINE

(71) Applicant: United Technologies Corporation, Farmington, CT (US)

(72) Inventors: Dennis M. Moura, South Windsor, CT (US); Carey Clum, East Hartford, CT (US)

(21) Appl. No.: 16/210,434

(22) Filed: Dec. 5, 2018

Related U.S. Application Data
(60) Provisional application No. 62/607,606, filed on Dec. 19, 2017.

(51) Int. Cl. F23R 3/00; F23M 5/08

(52) U.S. Cl. CPC F23R 3/002; F23M 5/08; F23R 2900/00004; F05D 2260/201; F05D 2240/35; F05D 2260/607; F23R 2900/03044

(57) ABSTRACT

A gas turbine engine component assembly comprising: a first component having a first surface, a second surface opposite the first surface, a first cooling hole located in a first section of the first component extending from the second surface to first surface, and a second cooling hole located in a second section of the first component extending from the second surface to first surface; a second component having a first surface and a second surface, the first surface of the first component and the second surface of the second component defining a cooling channel therebetween in fluid communication with the cooling hole for cooling the second surface of the second component; wherein the first cooling hole is configured to direct at least one of the airflow and the particulate to impinge upon the second surface of the second component at first directional flow angle.

### CROSS-REFERENCE TO RELATED APPLICATIONS

This application claims the benefit of U.S. Provisional Application No. 62/607,606 filed Dec. 19, 2017, which is incorporated herein by reference in its entirety.

### BACKGROUND

The subject matter disclosed herein generally relates to gas turbine engines and, more particularly, to method and apparatus for mitigating particulate accumulation on cooling surfaces of components of gas turbine engines.

In one example, a combustor of a gas turbine engine may be configured and required to burn fuel in a minimum volume. Such configurations may place substantial heat load on the structure of the combustor (e.g., panels, shell, etc.). Such heat loads may dictate that special consideration is given to structures, which may be configured as heat shields or panels, and to the cooling of such structures to protect these structures. Excess temperatures at these structures may lead to oxidation, cracking, and high thermal stresses of the heat shields or panels. Particulates in the air used to cool these structures may inhibit cooling of the heat shield and reduce durability. Particulates, in particular atmospheric particulates, include solid or liquid matter suspended in the atmosphere such as dust, ice, ash, sand and dirt.

### SUMMARY

According to one embodiment, a gas turbine engine component assembly is provided. The gas turbine engine component assembly comprising: a first component having a first surface, a second surface opposite the first surface, a first cooling hole located in a first section of the first component extending from the second surface to first surface, and a second cooling hole located in a second section of the first component extending from the second surface to first surface; a second component having a first surface and a second surface, the first surface of the first component and the second surface of the second component defining a cooling channel therebetween in fluid communication with the cooling hole for cooling the second surface of the second component; wherein the first cooling hole is configured to direct at least one of the airflow and the particulate to impinge upon the second surface of the second component at first directional flow angle, and wherein the second cooling hole is configured to direct at least one of the airflow and the particulate to impinge upon the second surface of the second component at a second directional flow angle different from the first directional flow angle.

In addition to one or more of the features described above, or as an alternative, further embodiments may include that the first cooling hole is configured to direct at least one of the airflow and the particulate to impinge upon the second surface of the second component at a first impingement angle, and wherein the second cooling hole is configured to direct at least one of the airflow and the particulate to impinge upon the second surface of the second component at a second impingement angle different from the first impingement angle.

In addition to one or more of the features described above, or as an alternative, further embodiments may include that at least one of the first impingement angle and the second impingement angle is non-perpendicular.

In addition to one or more of the features described above, or as an alternative, further embodiments may include that that first cooling hole is formed in the first component with a non-perpendicular primary aperture angle.

In addition to one or more of the features described above, or as an alternative, further embodiments may include that the second cooling hole is formed in the first component with a non-perpendicular primary aperture angle.

In addition to one or more of the features described above, or as an alternative, further embodiments may include that the first directional flow angle is equivalent to a directional angle of a local cross-flow path within the cooling channel.

In addition to one or more of the features described above, or as an alternative, further embodiments may include that the second directional flow angle is equivalent to a directional angle of a local cross-flow path within the cooling channel.

In addition to one or more of the features described above, or as an alternative, further embodiments may include that the second surface of the second component is non-planar to the first surface of the first component.

According to another embodiment, a shell of a combustor for use in a gas turbine engine is provided. The shell comprising: a combustion chamber of the combustor, the combustion chamber having a combustion area; a combustion liner having an inner surface, an outer surface opposite the inner surface, a first primary aperture located in a first section of the combustion liner extending from the outer surface to the inner surface through the combustion liner, and a second primary apertures located in a second section of the combustion liner extending from the outer surface to the inner surface through the combustion liner; a heat shield panel interposed between the inner surface of the combustion liner and the combustion area, the heat shield panel having a first surface and a second surface opposite the first surface, wherein the second surface is oriented towards the inner surface, and wherein the heat shield panel is separated from the combustion liner by an impingement cavity, wherein the first primary aperture is configured to direct at least one of the airflow and the particulate to impinge upon the second surface at first directional flow angle, and wherein the second primary aperture is configured to direct at least one of the airflow and the particulate to impinge upon the second surface at a second directional flow angle different from the first directional flow angle.

In addition to one or more of the features described above, or as an alternative, further embodiments may include that the first primary aperture is configured to direct at least one of the airflow and the particulate to impinge upon the second surface at a first impingement angle, and wherein the second primary aperture is configured to direct at least one of the airflow and the particulate to impinge upon the second surface at a second impingement angle different from the first impingement angle.

In addition to one or more of the features described above, or as an alternative, further embodiments may include that at least one of the first impingement angle and the second impingement angle is non-perpendicular.

In addition to one or more of the features described above, or as an alternative, further embodiments may include that the first primary aperture is formed in the combustion liner with a non-perpendicular primary aperture angle.

In addition to one or more of the features described above, or as an alternative, further embodiments may include that the second primary aperture is formed in the combustion liner with a non-perpendicular primary aperture angle.

In addition to one or more of the features described above, or as an alternative, further embodiments may include that the first directional flow angle is equivalent to a directional angle of a local cross-flow path within the impingement cavity.

In addition to one or more of the features described above, or as an alternative, further embodiments may include that the second directional flow angle is equivalent to a directional angle of a local cross-flow path within the impingement cavity.

In addition to one or more of the features described above, or as an alternative, further embodiments may include that the second surface is non-planar to the inner surface.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

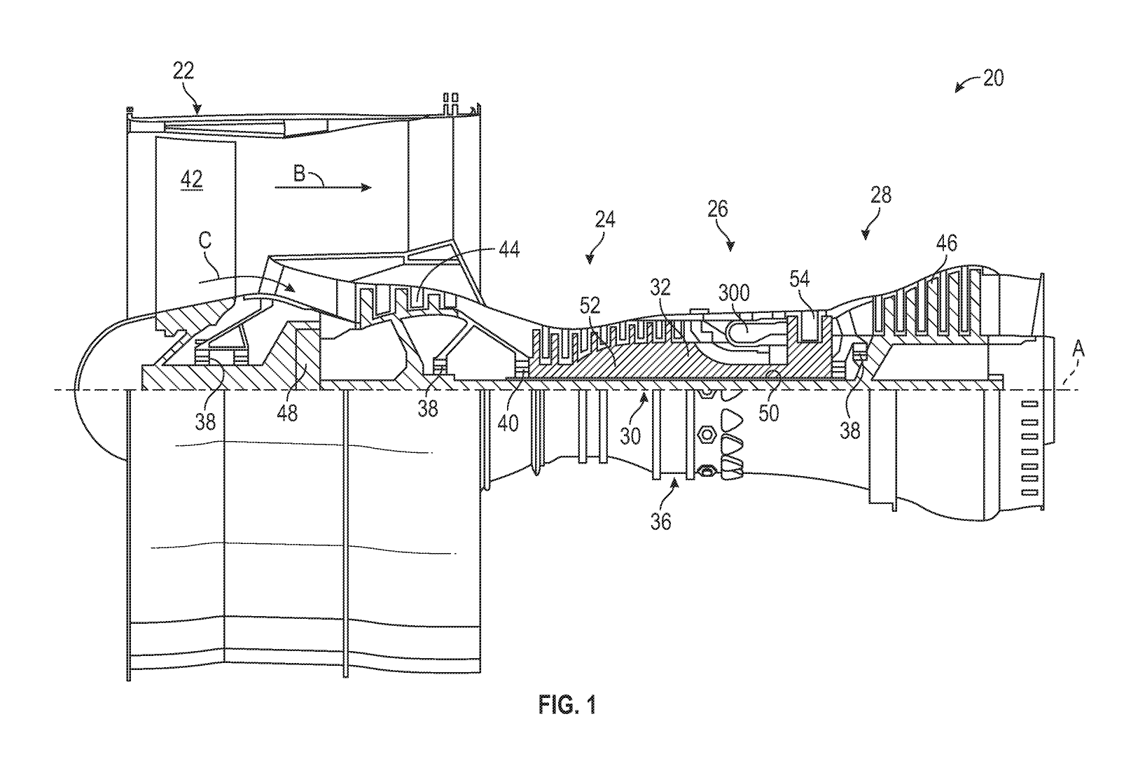

FIG. 1 is a partial cross-sectional illustration of a gas turbine engine, in accordance with an embodiment of the disclosure;

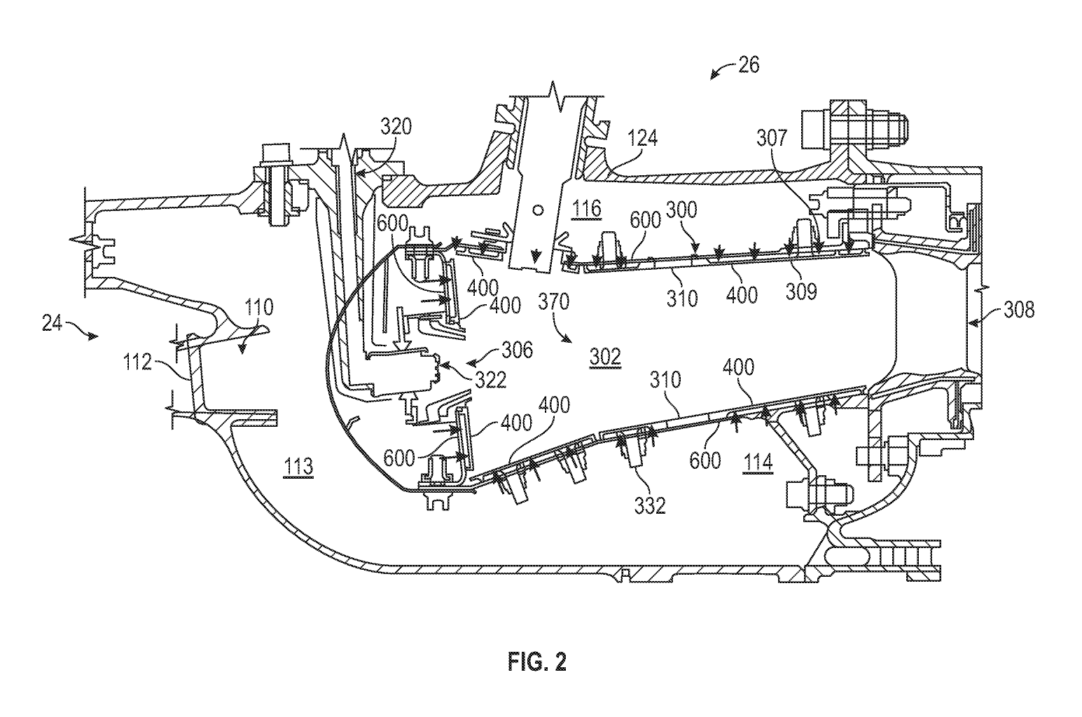

FIG. 2 is a cross-sectional illustration of a combustor, in accordance with an embodiment of the disclosure;

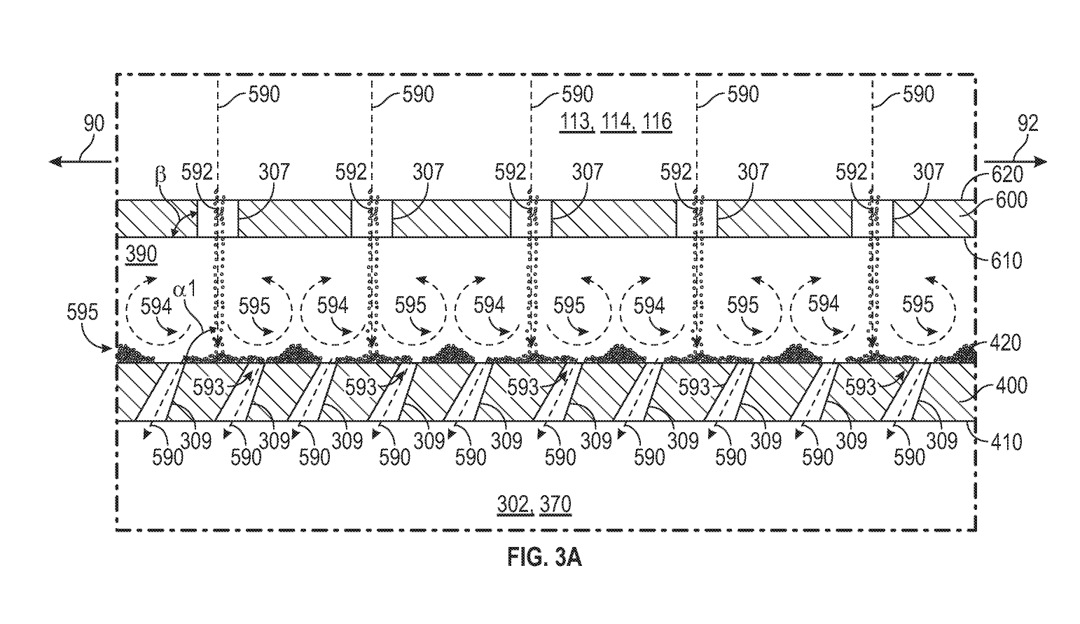

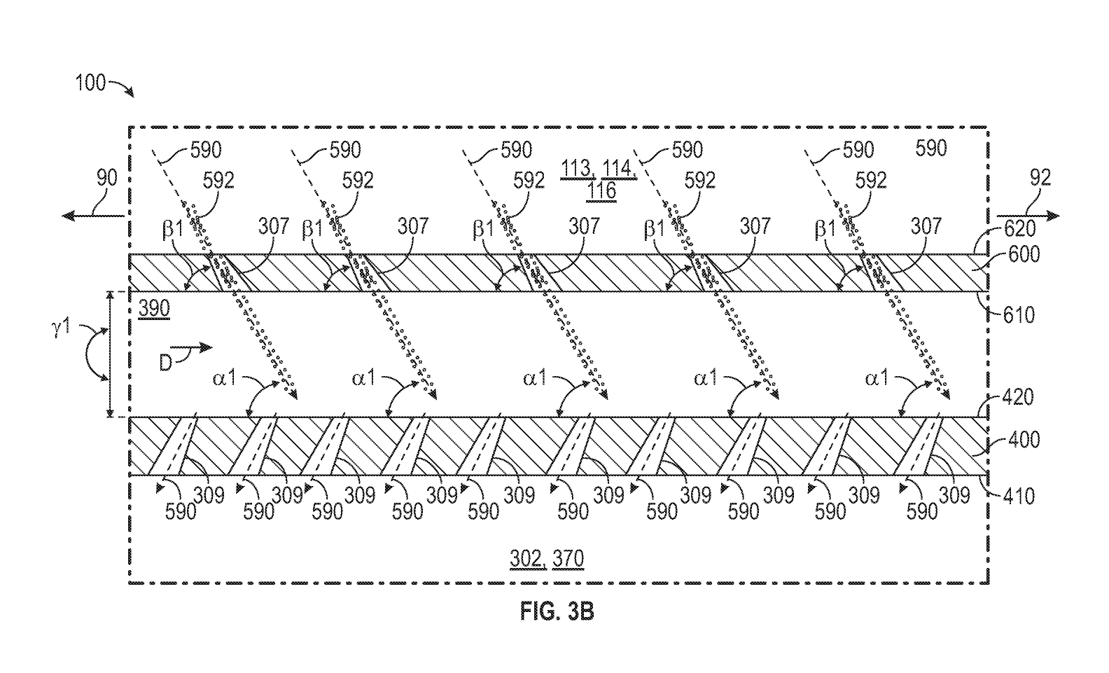

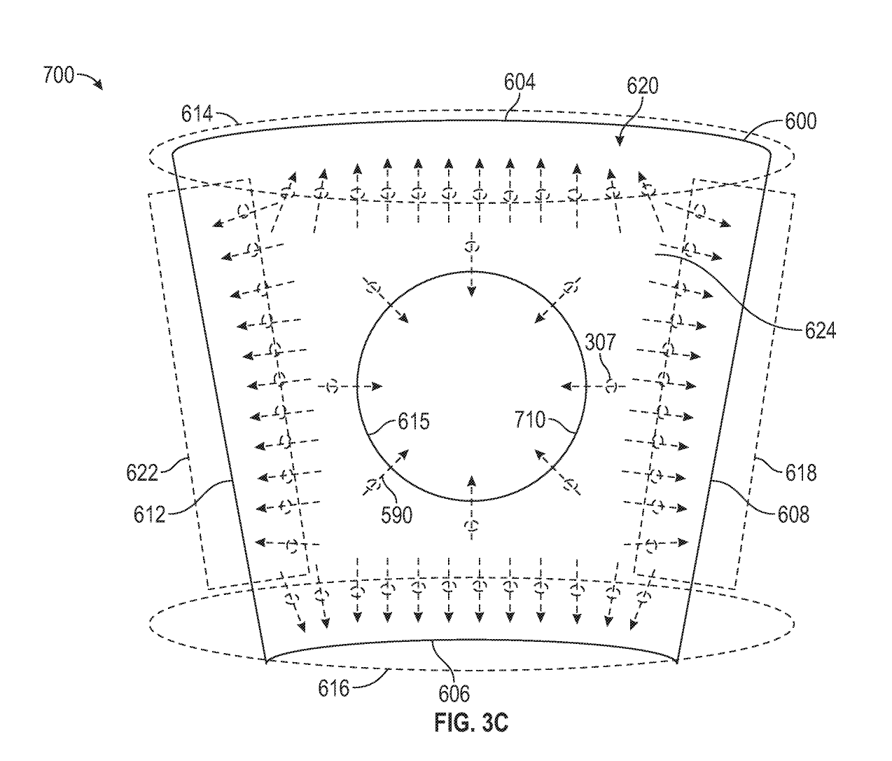

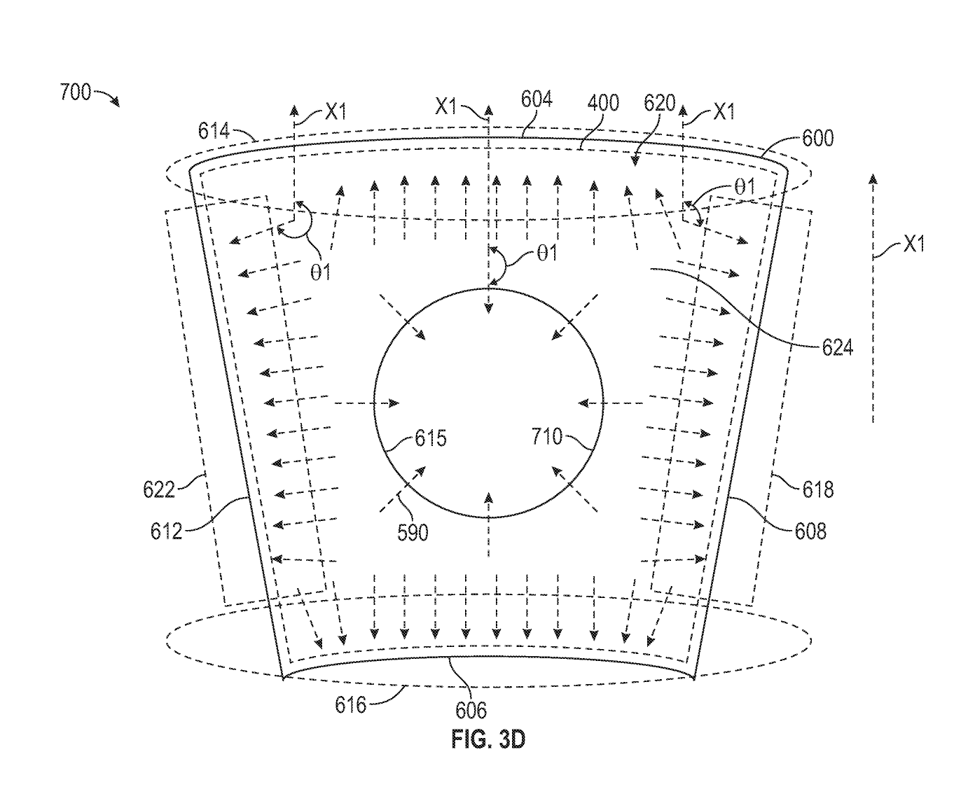

FIG. 3a is an enlarged cross-sectional illustration of a heat shield panel and combustion liner of a combustor, in accordance with an embodiment of the disclosure;

FIG. 3b is a cross-sectional illustration of a particulate collection mitigation system for a combustor of a gas turbine engine, in accordance with an embodiment of the disclosure;

FIG. 3c is an illustration of a bulkhead portion of a combustion liner for a combustor of a gas turbine engine, in accordance with an embodiment of the disclosure; and

FIG. 3d is an illustration of a bulkhead portion of a combustion liner for a combustor of a gas turbine engine, in accordance with an embodiment of the disclosure.

The detailed description explains embodiments of the present disclosure, together with advantages and features, by way of example with reference to the drawings.

### DETAILED DESCRIPTION

A detailed description of one or more embodiments of the disclosed apparatus and method are presented herein by way of exemplification and not limitation with reference to the Figures.

Combustors of gas turbine engines, as well as other components, experience elevated heat levels during operation. Impingement and convective cooling of panels of the combustor wall may be used to help cool the combustor. Convective cooling may be achieved by air that is channeled between the panels and a liner of the combustor. Impingement cooling may be a process of directing relatively cool air from a location exterior to the combustor toward a back or underside of the panels.

Thus, combustion liners and heat shield panels are utilized to face the hot products of combustion within a combustion chamber and protect the overall combustor shell. The space between the combustion liner and the heat shield panel is often called the impingement cavity. The combustion liners may be supplied with cooling air including dilution passages which deliver a high volume of cooling air into a hot flow path. The cooling air may be air from the compressor of the gas turbine engine. The cooling air may impinge upon a back side of a heat shield panel in the impingement cavity that faces a combustion liner inside the combustor. The cooling air may contain particulates, which may collect on the heat shield panels overtime, thus reducing the cooling ability of the cooling air. The collection of particulate on the heat shield panel may be due to aerodynamics within the impingement cavity. Aerodynamics in impingement cavity can be turbulent due to the expansion and mixing of the multitude of impingement airflows. This turbulence leads to locally low velocities, which may contribute to increased rate of dirt deposition on the backside of panels. Embodiments disclosed herein seek to address particulate adherence to the heat shield panels in order to maintain the cooling ability of the cooling air.

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 300 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 300, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

Referring now to FIG. 2 and with continued reference to FIG. 1, the combustor section 26 of the gas turbine engine 20 is shown. As illustrated in FIG. 2, a combustor 300 defines a combustion chamber 302. The combustion chamber 302 includes a combustion area 370 within the combustion chamber 302. The combustor 300 includes an inlet 306 and an outlet 308 through which air may pass. The air may be supplied to the combustor 300 by a pre-diffuser 110. Air may also enter the combustion area 370 of the combustion chamber 302 through other holes in the combustor 300 including but not limited to quench holes 310, as seen in FIG. 2.

As shown in FIG. 2, compressor air is supplied from a compressor section 24 into a pre-diffuser strut 112. As will be appreciated by those of skill in the art, the pre-diffuser strut 112 is configured to direct the airflow into the pre-diffuser 110, which then directs the airflow toward the combustor 300. The combustor 300 and the pre-diffuser 110 are separated by a shroud chamber 113 that contains the combustor 300 and includes an inner diameter branch 114 and an outer diameter branch 116. As air enters the shroud chamber 113, a portion of the air may flow into the combustor inlet 306, a portion may flow into the inner diameter branch 114, and a portion may flow into the outer diameter branch 116.

The air from the inner diameter branch 114 and the outer diameter branch 116 may then enter the combustion area 370 of the combustion chamber 302 by means of one or more primary apertures 307 in the combustion liner 600 and one or more secondary apertures 309 in the heat shield panels 400. The primary apertures 307 and secondary apertures 309 may include nozzles, holes, etc. The air may then exit the combustion chamber 302 through the combustor outlet 308. At the same time, fuel may be supplied into the combustion chamber 302 from a fuel injector 320 and a pilot nozzle 322, which may be ignited within the combustion area 370 of the combustion chamber 302. The combustor 300 of the engine combustion section 26 may be housed within a shroud case 124 which may define the shroud chamber 113.

The combustor 300, as shown in FIG. 2, includes multiple heat shield panels 400 that are attached to the combustion liner 600 (See FIG. 3a). The heat shield panels 400 may be arranged parallel to the combustion liner 600. The combustion liner 600 can define circular or annular structures with the heat shield panels 400 being mounted on a radially inward liner and a radially outward liner, as will be appreciated by those of skill in the art. The heat shield panels 400 can be removably mounted to the combustion liner 600 by one or more attachment mechanisms 332. In some embodiments, the attachment mechanism 332 may be integrally formed with a respective heat shield panel 400, although other configurations are possible. In some embodiments, the attachment mechanism 332 may be a bolt or other structure that may extend from the respective heat shield panel 400 through the interior surface to a receiving portion or aperture of the combustion liner 600 such that the heat shield panel 400 may be attached to the combustion liner 600 and held in place. The heat shield panels 400 partial enclose a combustion area 370 within the combustion chamber 302 of the combustor 300.

Referring now to FIGS. 3a, 3b, 3c, and 3d with continued reference to FIGS. 1 and 2. FIG. 3a illustrates a heat shield panel 400 and a combustion liner 600 of a combustor 300 (see FIG. 1) of a gas turbine engine 20 (see FIG. 1). The heat shield panel 400 and the combustion liner 600 are in a facing spaced relationship. FIG. 3b shows a particulate collection mitigation system 100 for a combustor 300 (see FIG. 1) of a gas turbine engine 20 (see FIG. 1), in accordance with an embodiment of the present disclosure. The heat shield panel 400 includes a first surface 410 oriented towards the combustion area 370 of the combustion chamber 302 and a second surface 420 first surface opposite the first surface 410 oriented towards the combustion liner 600. The combustion liner 600 has an inner surface 610 and an outer surface 620 opposite the inner surface 610. The inner surface 610 is oriented toward the heat shield panel 400. The outer surface 620 is oriented outward from the combustor 300 proximate the inner diameter branch 114 and the outer diameter branch 116.

The combustion liner 600 includes a plurality of primary apertures 307 configured to allow airflow 590 from the inner diameter branch 114 and the outer diameter branch 116 to enter an impingement cavity 390 in between the combustion liner 600 and the heat shield panel 400. Each of the primary apertures 307 extend from the outer surface 620 to the inner surface 610 through the combustion liner 600.

Each of the primary apertures 307 fluidly connects the impingement cavity 390 to at least one of the inner diameter branch 114 and the outer diameter branch 116. The primary apertures 307 are configured to direct airflow 590 towards the second surface 420 of the heat shield panel 400 and the directed airflow 590 provides cooling to the heat shield panel 400 when the airflow impinges on the second surface at an impingement point 594. The airflow 590 may strike or impinge upon the second surface 420 at an impingement angle α1, that is conventionally about 90° or about perpendicular. An impingement angle α1 about equal to 90° may lead to some turbulence of airflow 590 within the impingement cavity 390, which may lead to collection of particulate 592 on the second surface 420 of the heat shield panel 400, as described further below. The impingement angle α1 may be adjusted by the primary aperture angle β1 of each primary aperture 307 along with the angular orientation of the combustor liner 600 relative to the heat shield panel 400.

The heat shield panel 400 may include one or more secondary apertures 309 configured to allow airflow 590 from the impingement cavity 390 to the combustion area 370 of the combustion chamber 302. Each of the secondary apertures 309 extend from the second surface 420 to the first surface 410 through the heat shield panel 400. Airflow 590 flowing into the impingement cavity 390 impinges on the second surface 420 of the heat shield panel 400 at an impingement point 594 and absorbs heat from the heat shield panel 400 as it impinges on the second surface 420. As seen in FIG. 3a, particulates 592 may accompany the airflow 590 flowing into the impingement cavity 390. Particulate 592 may include but are not limited to dirt, smoke, soot, volcanic ash, or similar airborne particulate known to one of skill in the art. As the airflow 590 and particulates 592 impinge upon the second surface 420 of the heat shield panel 400, the pollutant particulate 592 may begin to collect on the second surface 420, as seen in FIG. 3a. Particulate 592 collecting upon the second surface 420 of the heat shield panel 400 reduces the cooling efficiency of airflow 590 impinging upon the second surface 420, and thus may increase local temperatures of the heat shield panel 400 and the combustion liner 600. Particulate 592 collecting upon the second surface 420 of the heat shield panel 400 may potentially create a blockage 593 to the secondary apertures 309 in the heat shield panels 400, thus reducing airflow 590 into the combustion area 370 of the combustion chamber 302. The blockage 593 may be a partial blockage or a full blockage.

Particulate 592 tends to collect at various collection points along second surface 420 of the heat shield panel 400. The collection points may include impingement points 594 and impingement flow convergence point 595. Impingement points 594 are points on the second surface 420 of the heat shield panel 400 where the airflow 590 and particulate 592 from a first primary aperture 307 is directed to impinge upon the second surface of the heat shield panel. Thus, each impingement points 594 is located opposite a primary aperture 307. When the airflow 590 and particulate 592 hit the second surface 594, the airflow and particulate 592 are forced to change direction abruptly, thus resulting in a loss of speed. The direction change will be either in a first direction 90 or a second direction 92. This direction change and loss of speed will result in some particulate 592 being separated from the airflow 590 and the particulates 590 that are separated will collect at the impingement point 594, as seen in FIG. 3a. The particulate 592 that does not collect at the impingement point 594 will be directed along with the airflow 592 either in a first direction 90 or a second direction 92 until the particulate 592 and airflow 590 converges at a impingement flow convergence point 595 with the particulate 592 and airflow 590 from a second primary aperture 307 adjacent to the first primary aperture 307, as seen in FIG. 3a. Each impingement flow convergence point 595 may be located about equally between two or more impingement points 594, as seen in FIG. 3a. At an impingement flow convergence point 595, the converging particulate 592 and airflow 590 is forced to change direction abruptly for a second time, thus resulting in a loss of speed. The second direction change will be towards the combustion liner 600. This second direction change and loss of speed will result in some particulate 592 being separated from the airflow 590 and the particulates 590 separated will collect at the impingement flow convergence point 595, as seen in FIG. 3a.

The combustion liner 600 may include one or more primary apertures 307 configured to direct at least one of airflow and particulate 592 to a second surface 420 to impinge upon the second surface 420 at an impingement angle α1 that is non-perpendicular (i.e. the impingement angle is not equal to 90°), as seen in FIG. 3b. In order to produce an impingement angle α1 that is non-perpendicular, the primary apertures 30 may be formed in the combustor liner 600 with a non-perpendicular primary aperture angle β1. The primary aperture angle β1 may be measured with respect to the inner surface 610, as seen in FIG. 3b. In an alternative embodiment, in order to produce an impingement angle α1 that is non-perpendicular, a plane angle γ1 measured between the inner surface 610 and the second surface 420 may be not equal to 180° (i.e. the second surface 420 is non-planar to the inner surface 610). In another alternative embodiment, a supplemental flow directing mechanism may be inserted into the primary aperture 307 to passively and/or actively direct the airflow 590 and/or particles 592 expelled from the primary aperture 307, thus adjusting the impingement angle α1. In an embodiment, the impingement angle α1 may be oriented such that at least one of the airflow 590 and particulates 592 are directed in a direction of a local cross-flow path D within the impingement cavity 390, as seen in FIG. 3b. Advantageously by impinging airflow 590 onto the second surface 420 at an angle relative to the second surface 420 that is non-perpendicular the cooling airflow 590 may be directed towards a preferential direction which can minimize the local low velocity regions.

A bulkhead portion 700 of the combustion liner 600 may be seen in FIGS. 3c and 3d. The bulkhead portion 700 may be located on the forward end of the combustor 300 and includes a through hole 710 configured to fit the combustor inlet 306 and pilot nozzle 322 of the fuel injectors 322. The combustor panel 600 may be sub-divided into separate sections and each section may include primary apertures 307 configured to direct the airflow 590 and particulate 592 (not shown in FIG. 3c) at different impingement angles α1 from each other section. In the example illustrated in FIG. 3c, the combustor panel 600 is sub-divided into 5 separate sections, each having primary apertures 307 configured to direct the airflow 590 and/or particulate 592 (not shown in FIG. 3c) at different impingement angles α1 and/or different directional flow angle Θ1. The directional flow angle Θ1 is the angle that the airflow 590 will be directed across the heat shield panel 400. The directional flow angle Θ1 may be measured relative to an axis X1. The directional flow angle Θ1 may be about equal to a local cross-flow path in the impingement cavity 390. Advantageously, if the directional flow angle Θ1 the local cross-flow path in the impingement cavity 390, the impediment of airflow 590 from the primary aperture 307 upon the cross-flow airflow 590 within the impingement cavity will be reduced.

In one example, each section may have primary apertures 307 with differing directional flow angles Θ1 between the sections. In another example, the primary apertures 307 within a section may have differing directional flow angles Θ1. In another example, each section may have primary apertures 307 with differing primary aperture angles β1 between the sections to produce differing impingement angles α1. The five sections include a radially outward section 614, a readily inward section 616, a first section 618, a second section 622, and a center section 624.

In the radially outward section 614, the primary apertures 307 are configured to direct the airflow 590 and/or particulate 592 (not shown in FIG. 3c) towards a radially outward side 604 of the bulkhead portion 700 of the combustion liner 600. In an embodiment, the primary apertures 307 in the radially outward section 614 may include a primary aperture angle β1 configured to direct the airflow 590 and/or particulate 592 (not shown in FIG. 3c) towards the radially outward side 604 of the bulkhead portion 700 of the combustion liner 600

In the radially inward section 616, the primary apertures 307 are configured to direct the airflow 590 and/or particulate 592 (not shown in FIG. 3c) towards a radially inward side 606 of the bulkhead portion 700 of the combustion liner 600. In an embodiment, the primary apertures 307 in the radially inward section 616 may include a primary aperture angle β1 configured to direct the airflow 590 and/or particulate 592 (not shown in FIG. 3c) towards the radially inward side 606 of the bulkhead portion 700 of the combustion liner 600

In the first section 618, the primary apertures 307 are configured to direct the airflow 590 and/or particulate 592 (not shown in FIG. 3c) towards a first side 608 of the bulkhead portion 700 of the combustion liner 600. In an embodiment, the primary apertures 307 in the first section 618 may include a primary aperture angle β1 configured to direct the airflow 590 and/or particulate 592 (not shown in FIG. 3c) towards the first side 608 of the bulkhead portion 700 of the combustion liner 600.

In the second section 622, the primary apertures 307 are configured to direct the airflow 590 and/or particulate 592 (not shown in FIG. 3c) towards a second side 612 of the bulkhead portion 700 of the combustion liner 600. In an embodiment, the primary apertures 307 in the second section 622 may include a primary aperture angle β1 configured to direct the airflow 590 and/or particulate 592 (not shown in FIG. 3c) towards the second side 612 of the bulkhead portion 700 of the combustion liner 600.

In the center section 624, the primary apertures 307 are configured to direct the airflow 590 and/or particulate 592 (not shown in FIG. 3c) towards to central side 615 of the bulkhead portion 700 of the combustion liner 600. In an embodiment, the primary apertures 307 in the center section 624 may include a primary aperture angle β1 configured to direct the airflow 590 and/or pollutant particulate 592 (not shown in FIG. 3c) towards the central side 615 of the bulkhead portion 700 of the combustion liner 600.

It is understood that a combustor of a gas turbine engine is used for illustrative purposes and the embodiments disclosed herein may be applicable to applications other than a combustor of a gas turbine engine.

Technical effects of embodiments of the present disclosure include directing impingement airflow within an impingement cavity to reduce airflow speed loss that results in particulate collection with the impingement cavity.

The term “about” is intended to include the degree of error associated with measurement of the particular quantity based upon the equipment available at the time of filing the application. For example, “about” can include a non-limiting range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A gas turbine engine component assembly, comprising:
a first component having a first surface, a second surface opposite the first surface, a first cooling hole located in a first section of the first component extending from the second surface to first surface, and a second cooling hole located in a second section of the first component extending from the second surface to first surface;
a second component having a first surface and a second surface, the first surface of the first component and the second surface of the second component defining a cooling channel therebetween in fluid communication with the cooling hole for cooling the second surface of the second component,
wherein the first cooling hole is configured to direct at least one of the airflow and the particulate to impinge upon the second surface of the second component at first directional flow angle, and
wherein the second cooling hole is configured to direct at least one of the airflow and the particulate to impinge upon the second surface of the second component at a second directional flow angle different from the first directional flow angle.

2. The gas turbine engine component assembly of claim 1, wherein the first cooling hole is configured to direct at least one of the airflow and the particulate to impinge upon the second surface of the second component at a first impingement angle, and wherein the second cooling hole is configured to direct at least one of the airflow and the particulate to impinge upon the second surface of the second component at a second impingement angle different from the first impingement angle.

3. The gas turbine engine component assembly of claim 2, wherein at least one of the first impingement angle and the second impingement angle is non-perpendicular.

4. The gas turbine engine component assembly of claim 1, wherein the first cooling hole is formed in the first component with a non-perpendicular primary aperture angle.

5. The gas turbine engine component assembly of claim 1, wherein the second cooling hole is formed in the first component with a non-perpendicular primary aperture angle.

6. The gas turbine engine component assembly of claim 1, wherein the first directional flow angle is equivalent to a directional angle of a local cross-flow path within the cooling channel.

7. The gas turbine engine component assembly of claim 1, wherein the second directional flow angle is equivalent to a directional angle of a local cross-flow path within the cooling channel.

8. The gas turbine engine component assembly of claim 1, wherein the second surface of the second component is non-planar to the first surface of the first component.

9. A shell of a combustor for use in a gas turbine engine, the shell comprising:
a combustion chamber of the combustor, the combustion chamber having a combustion area;
a combustion liner having an inner surface, an outer surface opposite the inner surface, a first primary aperture located in a first section of the combustion liner extending from the outer surface to the inner surface through the combustion liner, and a second primary apertures located in a second section of the combustion liner extending from the outer surface to the inner surface through the combustion liner;
a heat shield panel interposed between the inner surface of the combustion liner and the combustion area, the heat shield panel having a first surface and a second surface opposite the first surface, wherein the second surface is oriented towards the inner surface, and wherein the heat shield panel is separated from the combustion liner by an impingement cavity,
wherein the first primary aperture is configured to direct at least one of the airflow and the particulate to impinge upon the second surface at first directional flow angle, and
wherein the second primary aperture is configured to direct at least one of the airflow and the particulate to impinge upon the second surface at a second directional flow angle different from the first directional flow angle.

10. The shell of claim 9, wherein the first primary aperture is configured to direct at least one of the airflow and the particulate to impinge upon the second surface at a first impingement angle, and wherein the second primary aperture is configured to direct at least one of the airflow and the particulate to impinge upon the second surface at a second impingement angle different from the first impingement angle.

11. The shell of claim 10, wherein at least one of the first impingement angle and the second impingement angle is non-perpendicular.

12. The shell of claim 9, wherein the first primary aperture is formed in the combustion liner with a non-perpendicular primary aperture angle.

13. The shell of claim 9, wherein the second primary aperture is formed in the combustion liner with a non-perpendicular primary aperture angle.

14. The shell of claim 9, wherein the first directional flow angle is equivalent to a directional angle of a local cross-flow path within the impingement cavity.

15. The shell of claim 9, wherein the second directional flow angle is equivalent to a directional angle of a local cross-flow path within the impingement cavity.

16. The shell of claim 9, wherein the second surface is non-planar to the inner surface.
